(19) United States
(12) Patent Application Publication
(10) Pub. No.: US 2017/0064609 A1
(43) Pub. Date: Mar. 2, 2017

(54) ENRICHED LOCAL ADVERTISING FOR SMALL CELLS

(71) Applicant: QUALCOMM Incorporated, San Diego, CA (US)

(72) Inventors: Edwin Chongwoo Park, San Diego, CA (US); Soumya Das, San Diego, CA (US)

(21) Appl. No.: 14/839,549

(22) Filed: Aug. 28, 2015

(51) Int. Cl. H04W 48/10; H04W 8/06; H04W 72/04; H04W 36/00

(52) U.S. Cl. CPC H04W 48/10; H04W 36/0005; H04W 8/06; H04W 72/042; H04W 88/08

(57) ABSTRACT

Systems, methods, and apparatuses for enriched local advertising for small cells are described. A small cell or its components may host an advertising engine on an edge computing device that may be co-located with the small cell. The small cell may determine local information regarding an operating context of the mobile device in the small cell. The small cell may transmit advertising content to the mobile device based on the local information regarding the mobile device. The small cell may physically augment an output device in the small cell. The small cell may also serve a richer version of the advertising content to the mobile device based on local information regarding the mobile device, which may include physical location data for the mobile device. The small cell may be a small cell base station or wireless access point in close physical proximity to the mobile device.

### BACKGROUND

Field of the Disclosure

The present disclosure, for example, relates to wireless communication systems, and more particularly to an edge computing device co-located with a small cell base station.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple wireless devices. Base stations may communicate with wireless devices on downstream and upstream links. Each base station has a coverage range, which may be referred to as the coverage area of the cell. Some of these base stations may be lower-powered base stations, such as a picocells, femtocells, or microcells. Such small cell base stations cover a smaller geographic area than macrocell base stations and allow access by user equipments (UEs) with service subscriptions with the network provider.

Current wireless wide area networks (WWANs) generally place content and cloud resources on nodes outside of the mobile network operator's WWAN, far from the wireless device of the end user accessing the nodes on the other side of the WWAN. Similarly, users of wireless local area networks (WLAN) generally access content and cloud resources on these nodes, which makes the nodes also far from wireless device of the end user accessing the WLAN. When an end user connected to a wireless network near the edge of the WWAN or in a WLAN requests content or services, via their wireless device, the content is generally downloaded from these nodes, through the WWAN or WLAN, and delivered to the wireless device via a radio link. Subsequent requests for the same content result in the content being downloaded again from the nodes through the WWAN or WLAN to the wireless device. In addition, video traffic has increased to an ever-larger proportion of data transmitted over WWANs and WLANs. Unpredictable spikes in demand due to viral videos and live television programming, increases in display and content resolution, and the introduction of enhanced user features have all contributed to this increased growth in data usage. Duplication of requested content can waste resources on the backhaul and transport networks. Similarly, during times of high demand where traffic congestion may occur, content delivery may be affected such that the user experience is reduced. For example, costs of providing the requested data may rise, latency or buffering may increase, or the quality of delivered data may be reduced, e.g. by transcoding video from a higher quality level to a reduced quality level.

Furthermore, wireless devices may have limited battery life and processing power, mobile devices in particular. Applications and processes running on a wireless device, including to decode and encode content for transmission on the WWAN or WLAN, may use significant mobile device resources. Execution of these applications and processes may shorten battery life and degrade device performance.

### SUMMARY

Small cell base stations are radio access nodes that operate beneath the level of the macro cell base station infrastructure in a wireless network, e.g. microcells, femtocells, picocells, Wi-Fi access points, and access points that integrate wireless wide area network (WWAN) and wireless local area network (WLAN) functions. A small cell may include a base station that may be co-located with an edge computing device. The edge computing device may be integrated within a small cell base station or be a physically separate module in communication with and in close proximity with the small cell base station that provides edge computing resources at the small cell. A small cell base station or its components may host an advertising engine on an edge computing device that may be co-located with the small cell base station. The small cell base station may determine local information, including hyper-local information, regarding an operating context of the mobile device in the small cell. The small cell base station may transmit advertising content to the mobile device based on the local and/or hyper-local information regarding the mobile device. The small cell base station may physically augment the experience of a wireless device user using an output device in the small cell, for example by providing augmented reality images on top of local mapping data on a mobile device, adding sound, light, and/or other effects on a television, display or other output device The small cell base station may also serve a rich or richer version of the advertising content to the mobile device based on local information and context regarding the mobile device, which may include physical location data for the mobile device. The small cell may include a small cell base station or wireless access point in close physical proximity to the mobile device.

A method of wireless communication is described. The method may include hosting an advertising engine on an edge computing device that is co-located with a base station of a small cell, determining local information regarding an operating context of a mobile device in the small cell, and transmitting advertising content to the mobile device based at least in part on the local information regarding the mobile device.

An apparatus for wireless communication is described. The apparatus may include means for hosting an advertising engine on an edge computing device that is co-located with a base station of a small cell, means for determining local information regarding an operating context of a mobile device in the small cell, and means for transmitting advertising content to the mobile device based at least in part on the local information regarding the mobile device.

A further apparatus for wireless communication is described. The apparatus may include a processor, memory in electronic communication with the processor, and instructions stored in the memory and operable, when executed by the processor, to cause the apparatus to host an advertising engine on an edge computing device that is co-located with a base station of a small cell, determine local information regarding an operating context of a mobile device in the small cell, and transmit advertising content to the mobile device based at least in part on the local information regarding the mobile device.

A non-transitory computer-readable medium storing code for wireless communication is described. The code may include instructions executable by a processor to host an advertising engine on an edge computing device that is co-located with a base station of a small cell, determine local information regarding an operating context of a mobile device in the small cell, and transmit advertising content to the mobile device based at least in part on the local information regarding the mobile device.

Some examples of the method, apparatuses, or non-transitory computer-readable medium described herein may further include processes, features, means, or instructions for transmitting the advertising content to the mobile device comprises physically augmenting an output device in the small cell. Additionally or alternatively, some examples may include processes, features, means, or instructions for receiving a sensor input regarding the mobile device from a sensor in the small cell, wherein determining the local information regarding the operating context of the mobile device is based at least in part on the sensor input.

Some examples of the method, apparatuses, or non-transitory computer-readable medium described herein may further include processes, features, means, or instructions for transmitting a rich version of the advertising content to the mobile device based at least in part on the local information regarding the mobile device, wherein the local information comprises physical location data for the mobile device. Additionally or alternatively, some examples may include processes, features, means, or instructions for determining whether to transmit the rich version of the advertising content based at least in part on the local information regarding the mobile device, wherein the local information is one or more of a link quality for a link between the small cell and the mobile device, a power state of the mobile device, a memory availability value, a processing availability value, or a coexistence scenario for different radios of the mobile device.

Some examples of the method, apparatuses, or non-transitory computer-readable medium described herein may further include processes, features, means, or instructions for downloading the advertising content to the small cell from a remote advertising content server via a network, and modifying the advertising content based at least in part on the local information. Additionally or alternatively, some examples may include processes, features, means, or instructions for caching the modified advertising content at the small cell for access by the advertising engine.

Some examples of the method, apparatuses, or non-transitory computer-readable medium described herein may further include processes, features, means, or instructions for prefetching the advertising content to the edge computing device based at least in part on the local information regarding the operating context of the mobile device. Additionally or alternatively, some examples may include processes, features, means, or instructions for updating the advertising content based at least in part on the physical location data, wherein the local information comprises physical location data for the mobile device.

Some examples of the method, apparatuses, or non-transitory computer-readable medium described herein may further include processes, features, means, or instructions for analyzing a search request made by the mobile device to generate a search analysis, and prefetching the advertising content based at least in part on the search analysis. Additionally or alternatively, some examples may include processes, features, means, or instructions for processing analytics for the mobile device at the edge computing device.

Some examples of the method, apparatuses, or non-transitory computer-readable medium described herein may further include processes, features, means, or instructions for allocating processing of the analytics between the edge computing device and the mobile device. Additionally or alternatively, in some examples transmitting the advertising content to the mobile device comprises augmenting an output device in the small cell, wherein augmenting the output device is one or more of displaying an image, emitting a sound, emitting a smell, vibrating, or moving at the output device.

Some examples of the method, apparatuses, or non-transitory computer-readable medium described herein may further include processes, features, means, or instructions for receiving a sensor input regarding the mobile device from a sensor in the small cell, such that determining the local information regarding the operating context of the mobile device is based at least in part on the sensor input, wherein the sensor is one or more of a microphone, a temperature sensor, a light sensor, a camera, or an odor sensor. Additionally or alternatively, in some examples the local information regarding the operating context of the mobile device is one or more of a physical location of the mobile device, a trajectory of the mobile device, or information regarding a plurality of neighboring mobile devices.

In some examples of the method, apparatuses, or non-transitory computer-readable medium described herein, the advertising engine includes an advertising server, and transmitting the advertising content to the mobile device comprises serving the advertising content to the mobile device. Additionally or alternatively, some examples may include processes, features, means, or instructions for wireless communication resources of the base station are housed in a first module, and the edge computing device is housed in a second module in communication with and co-located with the first module.

In some examples of the method, apparatuses, or non-transitory computer-readable medium described herein, the base station is one of a picocell, a femtocell, a microcell, or a wireless fidelity (Wi-Fi) access point. Additionally or alternatively, in some examples the base station comprises a WWAN transceiver and a WLAN transceiver.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a block diagram of a wireless communications system, in accordance with various aspects of the present disclosure;

FIG. 1B shows a block diagram of a wireless communications network, in accordance with various aspects of the present disclosure;

FIG. 2 shows a block diagram of an edge computing device configured for use in a wireless communications system for enriched advertising for a small cell, in accordance with various aspects of the present disclosure;

FIG. 3 shows a block diagram of another edge computing device configured for use in a wireless communications system for enriched advertising for a small cell, in accordance with various aspects of the present disclosure;

FIG. 4 shows a diagram that illustrates a small cell base station configured for providing edge computing resources co-located with the small cell base station, in accordance with various aspects of the present disclosure;

FIG. 5 shows a block diagram of another small cell base station configured for providing edge computing resources co-located with the small cell base station, in accordance with various aspects of the present disclosure;

FIG. 6 shows a diagram that illustrates an edge computing device configured for providing edge computing resources co-located with the small cell base station, in accordance with various aspects of the present disclosure;

FIG. 7 illustrates an example of a process flow for enriched advertising for a small cell, in accordance with various aspects of the present disclosure; and

FIGS. 8-12 are flow charts illustrating examples of methods for wireless communication, in accordance with various aspects of the present disclosure.

### DETAILED DESCRIPTION

In the description that follows, an edge computing device may be co-located with a small cell base station. A small cell base station may include a wireless wide area network (WWAN) radio that operates in licensed and unlicensed spectrum. The WWAN radio may include adaptations that enable operation with other unlicensed band technologies. Small cell base stations, in addition to having WWAN radios, may have WLAN radios to connect to a WLAN (e.g. Wi-Fi, Wi-MAX, ZigBee, Bluetooth, etc.). Thus, a small cell base station may also act as a WLAN access point according to the present disclosure. Small cell base stations are radio access nodes that operate beneath the level of the macro cell infrastructure in a wireless network, e.g. microcells, femtocells, picocells, Wi-Fi access points, and access points that integrate WWAN and WLAN functions. Furthermore, small cell base stations have a range that is small compared to macro cell base stations. An edge computing device may be integrated within a small cell base station, or may be a physically separate device that is in communication with the small cell base station. In either case, an edge computing device may be in close proximity to a user's wireless device that is in communication with the edge computing device via the wireless resources of the small cell base station. The close proximity of small cell base stations to an associated wireless device's position may be harnessed to provide enhanced support and services to the wireless device and its users.

The described edge computing devices may support the dynamic distribution of processing of data and/or content between the edge computing device and a wireless device in communication with the edge computing device through a small cell base station. The edge computing devices may also prefetch content, for example webpages, content, and data, and cache it to the edge computing device based on the specific context of a wireless device determined relative to a small cell. An edge computing device may also host an advertising server or engine, providing enriched local advertising, augmented advertisement or other contents, and enabling the augmentation of a user's experience using an output display device in the proximity of the wireless device user. Examples of such augmentation may include providing augmented reality images on top of local mapping data on a mobile device, adding sound, light, and/or other effects on another device, for example on a television, display or other output device in an electronics store. In another example different colored blinking lights on a television or other display may be used to indicate the locations of different people as they move about the electronics store. The augmentation may be of actual reality, for example, by providing sounds, smells, visual stimuli, such as by means of lights, or physical objects, such as bubbles or confetti, to the user of a mobile or wireless device.

The edge computing devices discussed herein may also operate as enriched local advertising servers to augment advertising at the edge computing device or augment a user's experience at an output near the edge computing device. As used herein, advertising may refer to a commercial advertisement, for example to encourage a user to purchase a product or service, but may also refer to the display, communication, or other dissemination of information to a user. For example, a museum may user advertising to tell members of an audience where the displays are in a museum. In another example, a business, my advertising the location of a business meeting to tell a user where to go. These computing resources, as well as additional computing resources that may be surplus or provided specifically for this purpose, may also be provided to host applications, including third party applications, at the edge computing device and offer services for the small cell users. In some examples, a small cell platform is used to host applications/services for a group of neighboring small cells that may not have the spare compute and other resources (e.g., the small cells may have different capabilities). Surplus computing resources may be extra computing resources for use during a worst-case processor load. The difference between the total computing resources and the computing resources being used under a current processor load is the surplus computing resources. In some examples, the surplus computing resources are additional cores of a multi-core design that may be powered down when computing needs are less. In another example, the surplus computing resources may be a core that is designed for a maximum frequency but is currently operating at a lower frequency.

The described edge computing devices are located away from but are instead in close proximity to wirelessly-connected wireless devices, i.e. end users. The disclosed edge computing devices enable local analytics and knowledge generation to occur at the source of the data, near an end user, and leverages resources that may not be continuously connected to a network such as laptops, smartphones, tablets, and sensors. The herein described edge computing devices may improve response times for requests from wireless devices connected to the WWAN or WLAN, as well as increase the amount of data that can be used in environments where there is a limited data connection. Prefetching, caching, processing, and/or serving data at the edge computing devices, co-located with small cell base stations, may also reduce overall demand on the backhaul network or internet and help limit signaling and user traffic to and/or from core networks.

The following description provides examples that are not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

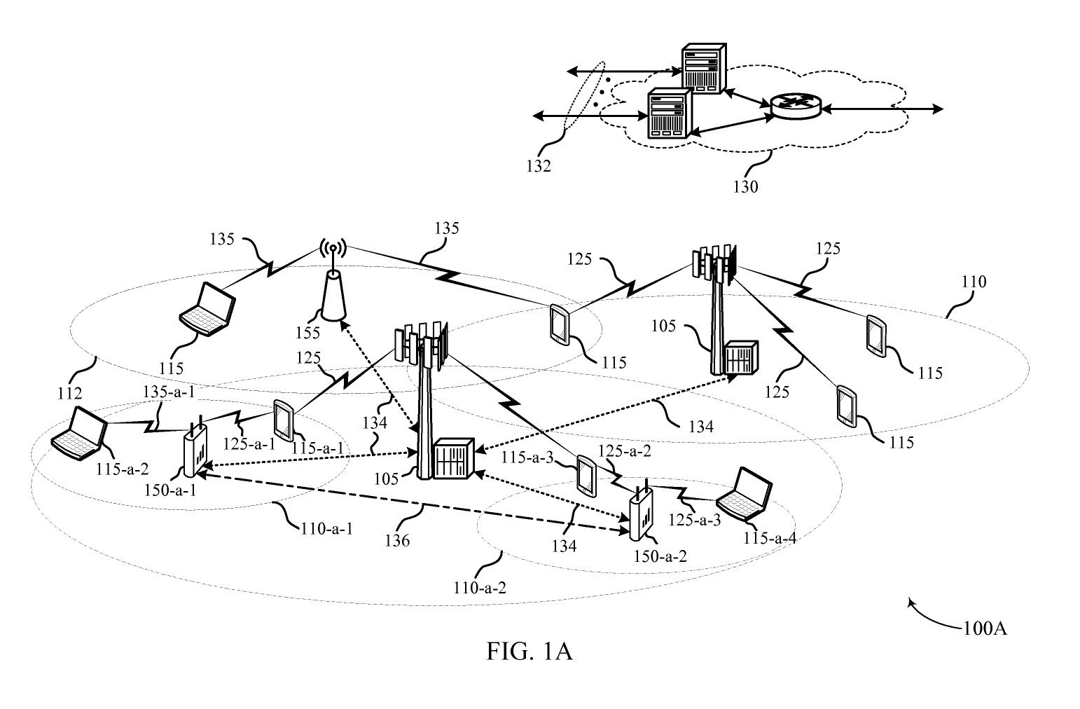

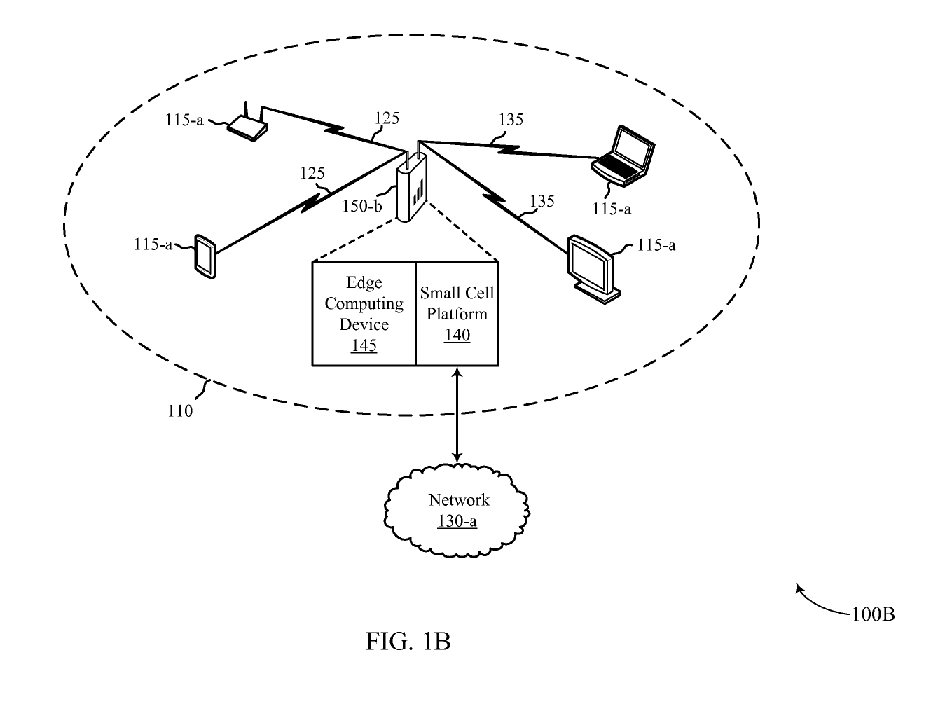

FIG. 1A shows a block diagram of a wireless communications system 100A in accordance with various aspects of the present disclosure. The wireless communications system 100A includes base stations 105, wireless devices 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the wireless devices 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the wireless devices 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB (HNB), a Home eNodeB (HeNodeB), access point, or some other suitable terminology. The geographic coverage area 110 for a base station 105 may be divided into sectors making up only a portion of the coverage area (not shown). The wireless communications system 100A may include base stations 105 of different types (e.g., macro cell base stations and/or small cell base stations). There may be overlapping geographic coverage areas 110 for different technologies.

In some examples, the wireless communications system 100A is a Long Term Evolution (LTE) or LTE-Advanced (LTE-A) network. In LTE/LTE-A networks, the term evolved Node B (eNB) may be generally used to describe the base stations 105, while the term user equipment (UE) may be generally used to describe the wireless devices 115. The wireless communications system 100A may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a term used by an organization named “3rd Generation Partnership Project” (3GPP) to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A base station for a macro cell may be referred to as a macro eNB or base station. A small cell may be associated with a lower-powered base station, as compared with a macro cell, that may operate in the same or different (e.g., licensed, unlicensed, etc.) frequency bands as a macro cell base station. A base station for a small cell may be referred to as a small cell, a small cell eNB, a small cell base station, a pico eNB or base station, a femto eNB or base station, or a home eNB or base station. A small cell may refer to the communications and devices associated with a small cell base station. For example, small cell base station 150-a-1 may be associated with geographic coverage area 110-a-1, wireless device 115-a-1, communication link 125-a-1, wireless device 115-a-2, and communication link 135-a-1. Similarly, small cell base station 150-a-2 may be associated with geographic coverage area 110-a-2, wireless device 115-a-3, communication link 125-a-2, wireless device 115-a-4, and communication link 125-a-3. A small cell may include picocells, femtocells, and microcells according to various examples. A picocell may cover a geographic coverage area 110 that is relatively smaller and may allow unrestricted access by UEs with service subscriptions with the network provider. A femtocell also may cover a relatively small geographic area (e.g., a home) and may provide restricted access by UEs having an association with the femtocell (e.g., UEs in a closed subscriber group (CSG), UEs for users in the home, open and multi-operator, and the like). Because a femtocell covers a relatively small geographic footprint, the computing needs of a femtocell may vary significantly from femtocell to femtocell. For example, a femtocell that covers an aisle in a grocery store may have different responsibilities than a femtocell in a library aisle. Thus, femtocells may experience a larger variance in computing needs than macrocells.

Small cell base stations 150 may also include WLAN radios, and may additionally function as a Wi-Fi access point (AP) for wireless devices 115. Wireless devices 115 may communicate with a small cell base station 150 having Wi-Fi functionality using communication links 135. The small cell base stations 150 may also communicate directly with each other using communication links 136, which may be wired or wireless, and may also communicate with each other using backhaul links 134. The wireless devices 115 may be Wi-Fi only devices or operate in a Wi-Fi only mode.

The wireless communications system 100A may support synchronous or asynchronous operation. For synchronous operation, the base stations 105 and small cell base station 150 may have similar frame timing, and transmissions from different base stations 105 or small cell base stations 150 may be approximately aligned in time. For asynchronous operation, the base stations 105 or small cell base stations 150 may have different frame timing, and transmissions from different base stations 105 or small cell base stations 150 may not be aligned in time. The techniques described herein may be used for either synchronous or asynchronous operations.

The wireless devices 115 are dispersed throughout the wireless communications system 100A, and each wireless device 115 may be stationary or mobile. A wireless device 115 may also include or be referred to by those skilled in the art (including herein) as a mobile station, a subscriber station, a mobile unit, a subscriber unit, a wireless unit, a remote unit, a mobile device, a wireless communications device, a remote device, a mobile subscriber station, an access terminal, a mobile terminal, a wireless terminal, a remote terminal, a handset, a user agent, a UE, a mobile client, a client, or some other suitable terminology. A wireless device 115 may be a cellular phone, a personal digital assistant (PDA), a wireless modem, a wireless communication device, a handheld device, a tablet computer, a laptop computer, a cordless phone, a wireless local loop (WLL) station, or the like. A wireless device 115 may be able to communicate with various types of base stations 105, small cell base stations 150, and network equipment including macro eNBs, small cell eNBs, relay base stations, and the like.

The communication links 125 shown in wireless communications system 100A may include uplink (UL) transmissions from a wireless device 115 to a base stations 105, and/or downlink (DL) transmissions, from a base stations 105 to a wireless device 115. The downlink transmissions may also be called forward link transmissions while the uplink transmissions may also be called reverse link transmissions. Each of the communication links 125 may include one or more carriers, which may be able to carry one or more waveform signals of different frequencies. The waveform signals may be modulated according to the various radio technologies described above. Each modulated signal may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the wireless communications system 100A, base stations 105, small cell base stations 150, and/or wireless devices 115 may include multiple antennas for employing antenna diversity schemes to improve communication quality and reliability between base stations 105 and wireless devices 115. Additionally or alternatively, base stations 105, small cell base stations 150, and/or wireless devices 115 may employ multiple-input, multiple-output (MIMO) techniques that may take advantage of multi-path environments to transmit multiple spatial layers carrying the same or different coded data.

Wireless communications system 100A may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A wireless device 115 may be configured with multiple downlink CCs and one or more uplink CCs for carrier aggregation. Carrier aggregation may be used with both FDD and TDD component carriers.

In some embodiments, the wireless communications system 100A may include an AP 155. Wireless devices 115 may communicate with an AP 155 using communication links 135, and each wireless device 115 may also communicate directly with one or more other of wireless devices 115 via a direct wireless link. Two or more wireless devices 115 may communicate via a direct wireless link when both wireless devices 115 are in the AP geographic coverage area 112 or when one or neither wireless device 115 is within the AP geographic coverage area (not shown). Examples of direct wireless links may include Wi-Fi Direct connections, connections established by using a Wi-Fi Tunneled Direct Link Setup (TDLS) link, and other peer-to-peer (P2P) group connections. The wireless devices 115 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented within wireless communications system 100A.

In addition to resources for communicating in wireless communications system 100A as a small cell base station, one or more of small cell base station 150-a-1 and small cell base station 150-a-2 may include or be associated with an edge computing device having a number of edge computing resources to support certain operations for wireless devices 115 wirelessly connected to a small cell base station 150-a-1 or small cell base station 150-a-2. Thus, the edge computing resources of one or more of small cell base station 150-a-1 and small cell base station 150-a-2 may support the dynamic distribution of processing of data and/or content between the small cell base station 150 and a wireless device 115 wirelessly connected to the small cell base station 150. The edge computing devices may also prefetch content and cache it to the edge computing device based on the specific context of a wireless device 115. An edge computing device may also host an advertising server or engine, providing enriched local advertising and physical augmentation of advertising. The edge computing device may also operate as enriched local advertising servers. Computing resources of the edge computing device may also be provided to host applications, including third party applications, on the edge computing device one or more of small cell base station 150-a-1 and small cell base station 150-a-2.

FIG. 1B shows a block diagram of a wireless communications network 100B. The wireless communications network 100B may include portions of wireless communications system 100A. The wireless communications network 100B may include a small cell base station 150-b and one or more wireless devices 115-a, such as mobile stations, PDAs, other handheld devices, netbooks, notebook computers, tablet computers, laptops, display devices (e.g., TVs, computer monitors, etc.), printers, etc. Each of the wireless devices 115-a may associate and communicate with small cell base station 150-b via one or more of communication links 125 and communication links 135. Each small cell base station 150-b has a geographic coverage area 110 such that wireless devices 115-a within that area can typically communicate with the small cell base station 150-b. The wireless devices 115-a may be dispersed throughout the geographic coverage area 110. Each wireless device 115-a may be stationary or mobile. In some examples, a wireless device 115-a can be covered by more than one small cell base station 150 and/or macro cell (not shown). In other examples, other wireless devices can communicate with the small cell base station 150-b.

Small cell base station 150-b includes a small cell platform 140 and an edge computing device 145. The edge computing device 145 may be integrated within a small cell base station 150-b with the small cell platform 140, or be a physically separate module communicating with and in close proximity with the small cell platform 140. Thus, the small cell base station 150-b may be a single integrated component, or may comprise a greater number of separate components that are communicatively couple together. In some cases, the small cell platform 140 encapsulates the edge computing device 145. In such instances, the extra processing power on the small cell platform 140 is the edge computing device 145. Small cell base station 150-b, and small cell platform 140 specifically, may communicate with core network 130-a, as well as provide connectivity with core network 130-a for the edge computing device 145 and wireless devices 115-a. Small cell base station 150-b and small cell platform 140 specifically, may also provide connectivity for edge computing device 145 with wireless devices 115-a.

Edge computing device 145 provides a number of edge computing resources and functions at the small cell base station 150-b that will be further set out below and in greater detail throughout this disclosure.

The edge computing device 145 may provide processing resources to support one or more wireless devices 115-a. Processing of data may be dynamically allocated between a wireless device 115-a and an edge computing device 145 co-located with the small cell base station 150-b. Processing responsibilities for data downloaded and to be delivered to the wireless device 115-a can be allocated to the wireless device 115-a, to the edge computing device 145, or split between the wireless device 115-a and the edge computing device 145. The allocation of processing responsibilities can be dynamic, for example based on a state of the wireless device 115-a, the quality of the radio link between the small cell base station 150-b and the wireless device 115-a, and/or the type of data to be delivered to the wireless device 115-a. The edge computing device 145 may be allocated responsibility to decompress (decode) data that is compressed (encoded) based at least in part on the type of compressed data, e.g. specifically for a particular type of compressed video, audio, or image data. Processing of compressed data by the edge computing device 145 may involve decompressing the compressed data, or processing compressed data into a less-compressed state, i.e. decompressing data compressed at a high level into an uncompressed state and then compressing the data using a compression algorithm or encoder using a lower compression level. The edge computing device 145 may also download multiple versions of the same compressed data, where one of the versions is sent to the wireless device 115-a based at least in part on a condition of the radio link or state of the wireless device 115-a. Processing responsibilities may also be allocated to the edge computing device 145 according to a state of the wireless device 115-a, for example power consumption at the wireless device 115-a, or processing capability, processing availability or headroom, battery state, coexistence problems due to concurrent utilization of different radios, or thermal state of the wireless device 115-a. Processing may be further allocated to the edge computing device 145 when the processing availability of the wireless device 115-a is below a threshold, when the battery life is below a threshold, where a temperature of the wireless device 115-a is above a threshold, or where the expected power consumption of the processing at the wireless device 115-a would exceed a predetermined power consumption threshold. The edge computing device 145 may also process, or not process, received data according to a processing capability report received from the wireless device 115-a. In addition, the edge computing device 145 may be allocated processing responsibility based on, for example, the observed quality of the radio link between the wireless device 115-a and the edge computing device 145/small cell base station 150-b, radio conditions, throughput, measurements, or expected future radio conditions (e.g., where the wireless device 115-a is travelling to, hand-off scenarios, loading, etc.).

Content may also be prefetched or otherwise retrieved by the edge computing device 145 and cached locally in anticipation of requests for such content from a wireless device 115-a. Prefetching of the content may be determined at least in part on information that is local, including hyper-local information, to the edge computing device 145. Such local information may include the physical location of the edge computing device 145, the physical location of the wireless device 115-a, or input about the physical location based on data gathered from a sensor or other input device of the edge computing device 145, e.g. from a microphone, temperature sensor, light sensor, or camera. Local information may also include previously assembled profiles for users of wireless device 115-a, including users' past requests for particular data. Local information may also relate to requests made by a user for related content. For example, for a video, prefetched content can include the same video previously requested by users of other wireless device 115-a, the next segment in a series of videos where a segment has been previously requested by a wireless device 115-a connected to the edge computing device 145, or videos related to a video previously fetched in response to a previous request from a wireless device 115-a.

Prefetching and locally caching at an edge computing device 145 may use additional storage capacity at the edge computing device 145, but it may be beneficial to allow content to be prefetched during periods of low usage of a backhaul network, saving bandwidth and decreasing latency. Prefetching may also potentially eliminate the need to repeatedly transport the same popular content from the source of the content to the requesting wireless device 115-a. Prefetching as described above may be especially beneficial where the content does not change substantially over time (e.g. a certain music video or audio file), and there is a higher likelihood that users of the wireless device 115-a will request such content via the edge computing device 145 prior to the content becoming stale. The prefetched content for a particular wireless device 115-a may also be transferred from a first edge computing platform to a second edge computing platform based on the expected physical location of the wireless device 115-a. Prefetching may also be performed when more power is available (e.g., the sun is out for small cells powered by solar panels) or when power levels are high (e.g., battery backup capacity is topping out). Further, pre-fetching can be performed being context aware. For example, augmented content can be pre-fetched in a small cell as opposed to augmentation being done on the small cell.

The edge computing device 145 discussed herein may also operate as an enriched local advertising server. Advertising at the edge computing device 145 or at an output near the edge computing device 145 may be physically augmented by the edge computing device 145. The edge computing device 145 may also serve advertisement data to the small cell base station 150-b and/or output near the small cell base station 150-b. An advertising server may run on the edge computing device 145, where the advertising server is configured to dynamically insert advertising content and data into content requested by the wireless device 115-a via the small cell base station 150-b. Specific advertising data and content may also be prefetched and cached at the edge computing device 145 based on the physical location of the edge computing device 145, and/or the location of the wireless device 115-a relative to the edge computing device 145. For example, an advertising server running on the edge computing device 145 may serve up content specifically targeted to users of wireless device 115-a operating in a sports stadium or grocery store aisle.

In some examples, prefetching and caching may be reactive. That is, prefetching and caching may be performed when the same or similar content is requested by at least one user. Content may be pre-fetched and cached when the small cell determines that the content is likely to be viewed by other users in the proximity. This determination may be based in part on, for example, user profiles for the users. Content may also likely be pre-fetched or consumed due to actions of other nearby users, who may not necessarily consuming the same content. Content may be pre-fetched and cached based on requested content on nearby or similar cells, which may be further based on demographics of the users.

The different edge nodes may have the same or differing storage and processing capabilities. In some examples, several small cells may form a cluster of small cells with a small cell acting as a cluster-head. The cluster-head small cell may be used for local storage, local service hosting, processing, and the like. In some examples, edge nodes have distributed processing and storage capabilities. Distributed caching may be performed amongst edge nodes (e.g., small cells). For example, some nodes may cache some content and other nodes cache other content (caching across sites can be a function of storage, backhaul, use, etc.). Caching can also be performed across multiple wireless devices, such as data being hashed across multiple devices.

Specific advertising data and content may also be prefetched and cached based at least in part on activity, usage of data (e.g., websites visited, metadata, or other information), or searches performed by a wireless device 115-a, or other information collected by small cell base station 150-b about wireless device 115-a, including wireless device 115-a previously connected to the small cell base station 150-b, or connected to other small cell base stations. This activity or information about wireless device 115-a may include contents of past search requests, meta data concerning wireless device 115-a, web site visitation or application usage history, or information from one or more sensors of wireless device 115-a, for example gyroscope, accelerometer, temperature, or GPS sensors. The advertising data and content may also be prefetched and cached based at least in part on analytics for activity performed by other wireless devices, including wireless devices previously connected to small cell base station 150-b or other small cell base stations such as neighboring base stations. Activity and information used for analytics may be the same as for wireless device 115-a, but also collected and analyzed for other wireless devices.

In addition, the advertising server can communicate with other local input/output devices to provide physical stimuli to the user of the wireless device 115-a in addition to the wireless device 115-a itself. For example, the advertising server may direct the edge computing device 145 to activate lights, displays, speakers, devices to distribute scents, smells or odors, or other output devices that are physically located in proximity to the edge device and/or wireless device 115-a in connection with a request for content from the wireless device 115-a.

The edge computing device 145 may also perform local analytics for a wireless device 115-a based on contextual data for the wireless device 115-a, for example the physical location or trajectory of the wireless device 115-a, or the location, surroundings, etc. of other wireless device 115-a connected to the small cell base station 150-b where the edge computing device 145 is located. Such performance of local analytics by an edge computing device 145 may enhance user experience (e.g., when the user is in a small cell area with a dense deployment). For example, a user in a congested network may experience delays due to an excess of wireless traffic. Additionally, a central entity responsible for performing analytics may not have the local contextual information needed to supply location-specific services. Thus, offloading certain analytics to an edge computing device 145 (or a small cell base station 150) may decrease service delays and enable service relevant to the specific location of the user. For example, running an ad server on a small cell base station 150 or edge computing device 145 may reduce latency and provide richer content (e.g., contextually or situationally relevant content). In some cases, processing may be moved to and from the edge computing device 145 and wireless device 115-a based on availability of processing power and needs. The processed analytics data concerning location, user searches, may inform Google® AdWords®, bidding for advertisement, etc.

Running an advertising server on the edge computing device 145 may allow the advertiser to serve richer advertising content by reducing the backhaul bandwidth required to serve the advertisements and reduce latency to deliver the advertisements to the user of the wireless device 115-a. As a result, it may be less expensive for a network operator to provide the advertising, because of the reduced use of network bandwidth, for example the backhaul network of a WWAN or an internet service provider (ISP) connected to a WLAN. In such a case, the WWAN network operator or ISP may provide a discounted data rate to the user of the wireless device 115-a for advertising data served to the wireless device 115-a from the network computing device.

As a result of the proximity of edge computing device 145 to the WWAN small cell base station or WLAN access point, the edge computing device 145 may also control proximate input/output devices, also connected to the edge computing device 145, to interact with and provide stimuli to the user of the wireless device 115-a according to a location of the user of the wireless device 115-a, sensor input from the wireless device 115-a or edge computing device 145, and/or the content of requests made by the wireless device 115-a user via the edge computing device 145.

The edge computing device 145 may also take in data concerning the location and environment of a wireless device 115-a, and by extension the user of the wireless device 115-a, to control input/output devices to stimulate a wireless device 115-a user. Sensor data for the wireless device 115-a and/or edge computing device 145 may be collected, e.g. from a microphone, temperature, or light sensor, or camera. Because of the close proximity of the wireless device 115-a and the edge network device to which the wireless device 115-a is connected as well as the known location of the edge computing device 145, the edge computing device 145 may then use this information to control, according to data at the edge computing device 145, a device external to the wireless device 115-a itself that is within the known proximity of the user of the wireless device 115-a. The external device may deliver or serve advertising content or data. For example, an external device may be controlled by the edge computing device 145 to annotate data content provided to the edge computing device 145 by the wireless device 115-a according to information specific to the physical environment of the edge computing device 145. Annotating may include annotating the data content with images or text. As another example, the edge computing device 145 may control an input/output device (external to the edge computing device 145) to provide a stimulus to the user of the wireless device 115-a based on at least one characteristic of the wireless device 115-a user determined from the edge computing device 145, for example a physical location of the wireless device 115-a by virtue of proximity to the small cell base station to which the wireless device 115-a is connected, or the content of a request made by the user of the wireless device 115-a.

The edge computing device 145 may also have surplus computing resources that may host third party applications. These computing resources may also be provided for such purpose. Mobile applications typically run on a wireless device 115-a or on a network component, such as a content delivery network, or other server. At the same time, wireless device 115-a generally have limited computing power and battery life, while an edge computing device 145 will likely have a dedicated power connection. Thus, edge computing device 145 may be configured to allow use by third-party applications in close proximity to the end user (i.e. the wireless device 115-a), but with fewer power and processing constraints than the wireless device 115-a.

In an example, an application running on a user's mobile device may be enhanced by a complementary application running on the edge computing device 145. The complementary application may provide processing that enhances the user experience, for example by monitoring incoming messages to the wireless device 115-a and sending alerts according to predefined parameters. The resources of the edge computing device 145 may also be provided as a service to a third party, for example by providing a virtual machine running on the edge computing device 145 to run the third party application. This way, the third party can provide an enhanced experience to the user of a wireless device 115-a by running the third party's own application in close proximity to the wireless device 115-a, but where the application is under the direction and control of the third party. The third party can cache selected data or content to the edge computing device 145, and provide an application to the wireless device 115-a that interacts with the cached data or content. The application of the wireless device 115-a may also be provided to interact with the application running on the edge computing device 145 or server. Thus, the wireless device 115-a application may interact with distant servers through the WWAN and/or internet less frequently, enhancing the experience of the wireless device 115-a user. In addition, computation performed by the third-party application for the wireless device 115-a may be moved or transferred from the edge computing device 145 to a second edge computing device to follow a wireless device 115-a of a user from the edge computing device 145 to the second edge computing device.

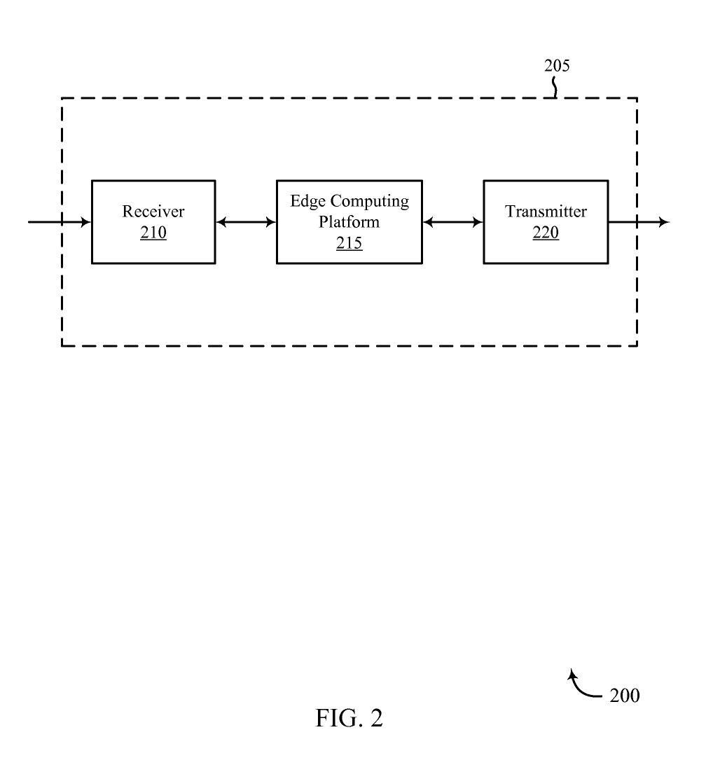

FIG. 2 shows a block diagram 200 of an edge computing device 205 configured for use in a wireless communications system for enriched advertising for a small cell, in accordance with various aspects of the present disclosure. The edge computing device 205 may be an example of one or more aspects of the edge computing device 145 described with reference to FIG. 1B. The edge computing device 205 may include a receiver 210, an edge computing platform 215, and/or a transmitter 220. The edge computing device 205 may also be or include a processor (not shown). Each of these modules may be in communication with each other. In some cases, the edge computing device 145-a may be integrated with a small cell base station 150. In such cases, the edge computing device 145-a may provide additional computing power for the small cell base station 150 and thus may not include the receiver 210 or the transmitter 220.

The edge computing device 205, through the receiver 210, the edge computing platform 215, and/or the transmitter 220, may be configured to perform functions described herein. For example, the edge computing device 205 may be configured to provide edge computing resources for a wireless device that is in communication with a small cell base station. Although the edge computing device 145-a is shown encapsulating the edge computing platform 245, in some cases, the edge computing platform 245 encapsulates the edge computing device 145-a. That is, the edge computing device 245 may surround or include the edge computing device 145-a, the received 210, and/or the transmitter 220. Thus, the edge computing platform 245 may leverage the functionality of the edge computing device 145-a to boost processing power.

The components of the edge computing device 205 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, formatted to be executed by one or more general or application-specific processors.

The receiver 210 may receive information such as packets, user data, and/or control information associated with various information channels (e.g., control channels, data channels, etc.). The receiver 210 may be configured to receive content, data, and other information requested from a network by a wireless device, which may include audio, video, advertising, webpage, or other data from a network at the request of a wireless device in communication with the edge computing device 205 in a small cell, requests for such content or data sent from a wireless device, as well as requests to use edge computing resources by wireless devices, and inputs from various sensor or input/output devices. Information may be passed on to the edge computing platform 215, and to other components of the edge computing device 205.

The transmitter 220 may transmit one or more signals received from other components of the edge computing device 205. The transmitter 220 may transmit audio, video, advertising, webpage, or other data to a wireless device in communication with the small cell base station such as with the edge computing device 205, responses to requests to use edge computing resources by wireless devices, and outputs to displays, lights, or other input/output devices. In some examples, the transmitter 220 may be co-located or integrated with the receiver 210 in a transceiver module.

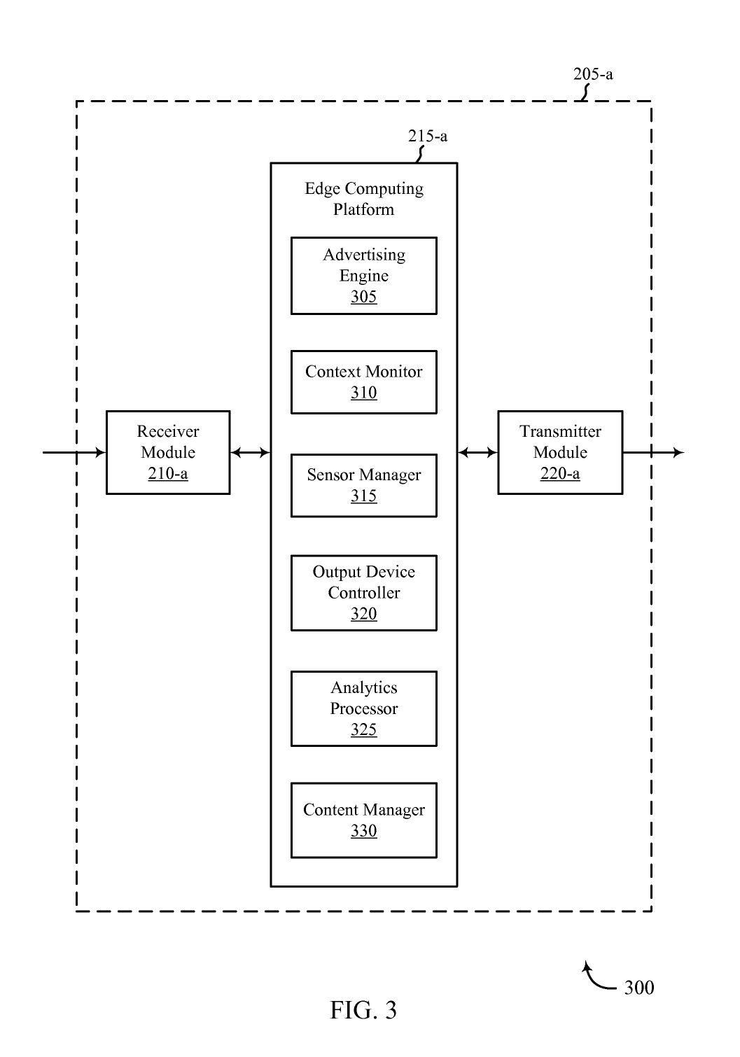

FIG. 3 shows a block diagram 300 of another edge computing device 205-a configured for use in a wireless communications system for enriched advertising for a small cell, in accordance with various aspects of the present disclosure. The edge computing device 205-a may be an example of one or more aspects of small cell base station 150 described with reference to FIGS. 1A and 1B. Edge computing device 205-a may include edge computing platform 215-a, receiver 210-a, and transmitter 220-a, which may be examples of edge computing platform 215, receiver 210, and transmitter 220 described with reference to FIG. 2. Edge computing platform 215-a may include advertising engine 305, context monitor 310, sensor manager 315, output device controller 320, analytics processor 325, and a content manager 330, which may include content storage entity. The edge computing device 205-a may also be or include a processor (not shown). Each of these modules may be in communication with each other.

Advertising engine 305 may run on the edge computing device 205-a to provide advertising analysis, management, and services related to one or more mobile devices that may be in wireless communication with a small cell base station. Advertising engine 305 may gather or access stored local information regarding the operating context of the mobile device in the small cell to make a determination regarding advertising content that should be sent to the mobile device or otherwise transmitted to a user of the mobile device through an output device.

Advertising engine 305 may determine or select a version of the advertising content that should be transmitted. For example, advertising engine 305 may have access to several versions of the same or similar advertising content stored at edge computing device 205-a, and depending on the operating context of a mobile device, select one of the versions of the advertising content to transmit to the mobile device. In an example, one of the versions may be a standard version of the advertising content that contain text and/or static images. Another of the versions of the advertising content may be a rich version of the advertising content that contains video, a downloaded applet (e.g. for a game, etc.), is expandable, tracks user interaction, and/or provides multiple click-throughs for the viewer of the content. Advertising engine 305 may make this determination or selection based on one or more of the following: local information about the mobile device, for example concerning the quality of the link between the small cell and the mobile device to whom the advertising content will be delivered; the power state of the mobile device, e.g. by refraining from sending certain types of content, such as rich advertisement content; the coexistence scenario of different simultaneously operating radios at the a wireless device 115; or other device capabilities, e.g. available memory or processing, etc. For example, a rich version of the advertising content may be transmitted when the available bandwidth is above a bandwidth threshold, and the standard version transmitted when the available bandwidth is below the bandwidth threshold. In another example, the advertising engine may request a latency measurement from the small cell base station for communications with a wireless device. Such a measurement may be taken for other purposes or periodically performed and the result stored. The standard version of the advertising content may be sent to the wireless device when a latency between the wireless device and the small cell base station is above a latency threshold, and the rich version sent when the latency is below a latency threshold. In general, because the advertising engine is co-located with the small cell base station and in close physical proximity to a wireless device in communication with the small cell base station, the advertising content served to the wireless device may be richer, i.e. have more features associated with rich advertising content.

The advertising content may be advertising content associated with the owner or operator of the small cell, or belong to a third party. The advertising content may be preloaded on the small cell base station, or downloaded from a remote advertising server via a network, e.g. a public network such as the Internet, and stored locally on the small cell base station.

Advertising engine 305 may also modify the advertising content based on local information. The modification may include inserting data, text, images, or other additional content into other advertising content, or joining different portions of advertising content to form a different piece of advertising content to deliver to a wireless device or a user of a wireless device. Advertising engine 305 may insert content, including data, images, or text captured from an input device coupled to the small cell base station. For example, where an input device is a camera, the advertising engine may insert an image taken with the camera into existing advertising content to deliver to the wireless device or a user of the wireless device. In one example, advertising engine 305 may be part of a processor (not shown) of edge computing device 205-a. In another example, advertising engine 305 may be implemented as software configured to executed by a processor (not shown) of edge computing device 205-a.

The advertising engine 305 may also receive data from the sensor manager 315 regarding an observed feature of the physical location of the small cell base station, and select advertising content or modify existing advertising content based on the observed feature. For example, the sensor manager 315, as further discussed below, may determine that someone is wearing a particular brand of clothing by use of a camera or other sensor. Advertising engine 305 may then transmit advertising content related to that particular brand, e.g. advertising for that brand of clothing, for a competitor's brand of clothing, etc. In another example, the sensor manager 315, as further discussed below, may determine that someone is discussing a particular feature or size of an article of clothing. Advertising engine 305 may then transmit advertising content related that feature or size, e.g. advertising other clothing with that feature, that is present in a store in that size, etc.

Context monitor 310 monitors the operating context of one or more wireless devices. The local information may include a physical location or trajectory of the wireless device or a user of a wireless device. The physical location or trajectory may be determined from information obtained from the mobile device concerning its coordinates or change in coordinates. The physical location or trajectory may also be determined based on the known physical location of the edge computing device associated with the small cell base station with which the wireless device is communicating. Because a small cell is confined to a small local coverage area, for example confined to a building, store, park, or other local area, a context of the connected mobile device may also be determined from the physical location of the small cell base station itself. Context monitor 310 may also receive input from sensor manager 315 regarding the context of the wireless device. For example, sensor manager 315 may provide the information to the context monitor that someone is discussing a particular brand near a microphone sensor. In another example, sensor manager 315 may provide information concerning the temperature or precipitation outside of a building that houses the small cell base station. The context monitor 310 may then track and manage this data and information, and provide it for use by advertising engine 305.

Sensor manager 315 receives a number of sensor inputs, and processes them to provide local information regarding the operating context of a mobile device as well as other data for other components of edge computing platform 215-a. Sensor inputs may be received from sensors coupled to edge computing device 205-a. Such sensors may include sensors to receive or measure light, sound, temperature, humidity, touch, smells, or motion, e.g. a microphone, a temperature sensor, a light sensor, an accelerometer, a gyroscope, a camera, an odor sensor, etc. The sensors may be internal or external to edge computing device 205-a. For example, a temperature sensor may be internal to edge computing device 205-a, and read by the sensor manager 315 via a wired connection. External sensors may be connected to edge computing device 205-a via a wired or wireless connection. For example, along with one or more mobile devices, a camera may be in wireless communication with a small cell base station. Sensor manager 315 may then receive signals from the camera via the wireless connection.

Sensor manager 315 may also process the received signals from one or more sensors to provide data to the advertising engine 305. For example, a camera communicating with a small cell base station in a retail store may capture video of shoppers in the store. Sensor manager 315 may then receive the video signal from the camera, and process the video signal using an image recognition application. In one example, the sensor manager 315 may detect certain brand names or images in the video signal. The sensor manager 315 may then provide brand data to advertising engine 305 regarding detected brand names or images. As discussed above, the sensor manager 315 may then transmit or serve advertising based on the brand data. In another examples, advertising content may be based on other information determined using sensor manager 315 may determine or estimate an age or gender of a user based on the video signal. In yet another example, the sensor manager 315 may determine a group composition of a group of persons based on the video signal, including whether a user is alone, with another person, part of a family, part of a family with kids, etc. In other examples, the sensor manager 315 may determine loitering times, or other times for a user to remain in the frame of a camera. When a user lingers for a shorter amount of time to view an advertisement, advertisements with less text or short videos may be displayed to the user; when a user lingers for longer period of time, an advertisement with a greater amount of text or a longer video may be displayed. In another example implementation, the sensor manager 315 may interface with a paging system to send a real or virtual assistant to the location of the user, for example to answer question or provide other assistance. The virtual assistant may be a computer bot such as Apple® Ski® or Microsoft® Cortana®. In some examples, the small cell may track the physical location of a user so that the user's proximity to certain items within the store may be determined. In another example, a microphone may communicate with the small cell base station in a store, restaurant, airport, or other public location. Sensor manager 315 may receive audio data from the microphone and process the audio signal using a speech recognition application to detect certain brand names or other key words in the audio signal. In each of the above example, sensor manager 315 may detect changes in the sensed values, which it may report to one or more of the advertising engine or analytics processor 325. As discussed above, sensor manager 315 may then send information regarding the brand names or other key words to advertising engine 305, which may use such information to transmit or serve advertising content.

Output device controller 320 controls one or more output devices coupled to edge computing device 205-a. Such output devices may include displays, lights, array of lights, projectors, signs, printers, speakers, vibrators, odor emitters, or other devices that provide a physical output. These output devices may display an image, emit a sound, emit a smell, vibrate, or move at the output device under the control of output device controller 320. The output devices may be external to or integrated with edge computing device 205-a. For example, output device controller 320 may receive an instruction from advertising engine 305 to control a particular display to display an advertising image for a certain period of time. Output device controller 320 may then communicate with and control the display. In another example, advertising engine 305 may instruct the output device controller 320 to play an audible advertisement related to a particular product in a certain area of a store to gain the attention of a shopper in that area. Output device controller 320 may then control a corresponding speaker to play an audio track related to that product in the requested area of the store.

Analytics processor 325 may process analytics at the edge computing device 205-a based on contextual data for the mobile device, for example the physical location or trajectory of a mobile device connected to the small cell base station, or location, surroundings, etc. of other mobile devices connected to the small cell base station co-located with edge computing device 205-a. Analytics processor 325 may analyze information collected and processed by sensor manager 315. As further discussed above, such information may include usage of brand names or images, use of other key words, linger or loiter times, group composition and association, or a user's location or proximity to certain items. In some examples analytics processor 325 may analyze search requests or other requests for data or content made by a connected mobile device to generate a search analysis. Analytics processor 325 may also analyze search requests or other requests for data or content made by one or more other mobile devices to generate an analysis report. Analytics processor 325 may also analyze location information for the mobile device. In addition, analytics processor 325 may send an analysis report to advertising engine 305 to indicate that advertising content should be directed to a mobile device (transmitted to the mobile device or an output device near the mobile device) based on prior searches or requests for data from other mobile devices. The processed analytics data, including the analysis report, may also inform Google® AdWords®, bidding for advertisements, etc. In one example, analytics processor 325 may be part of a processor (not shown) of edge computing device 205-a. In another example, analytics processor 325 may be implemented as software configured to executed by a processor (not shown) of edge computing device 205-a.

A search may be a request made by a mobile device to a search engine over a network, such as a public network. A search may also be a request for data from another service, for example a request by a mobile device to Apple, Inc.'s Ski® or Google Now™ service, which analytics processor 325 may intercept and analyze where the request is made by the mobile device. The processed analytics data concerning location, user searches, may inform Google® AdWords®, bidding for advertisement, etc.

Analytics processor 325 may process some analytics data, while the mobile device related to the analytics data may process some of the analytics data. Analytics processor 325 may then manage the distribution of processing of analytics between the mobile device and edge computing device 205-based at least in part on the availability of processing power for the mobile device and the edge computing device 205-a.

Content manager 330 manages, organizes, and provides access for content and data, including advertising content or data, for example the results of analytics processing. Content manager 330 may include or interface with various applications, file servers and/or databases. Content manager 330 may receive content or data downloaded or cached to edge computing device 205-a, received via receiver module 210-a, or provide content or data to be transmitted via transmitter module 220-a. Content manager 330 may also receive content or data described above from, or provide such content or data to, the advertising engine 305, context monitor 310, sensor manager 315, output device controller 320, or analytics processor 325. For content or data having multiple versions or relationships,

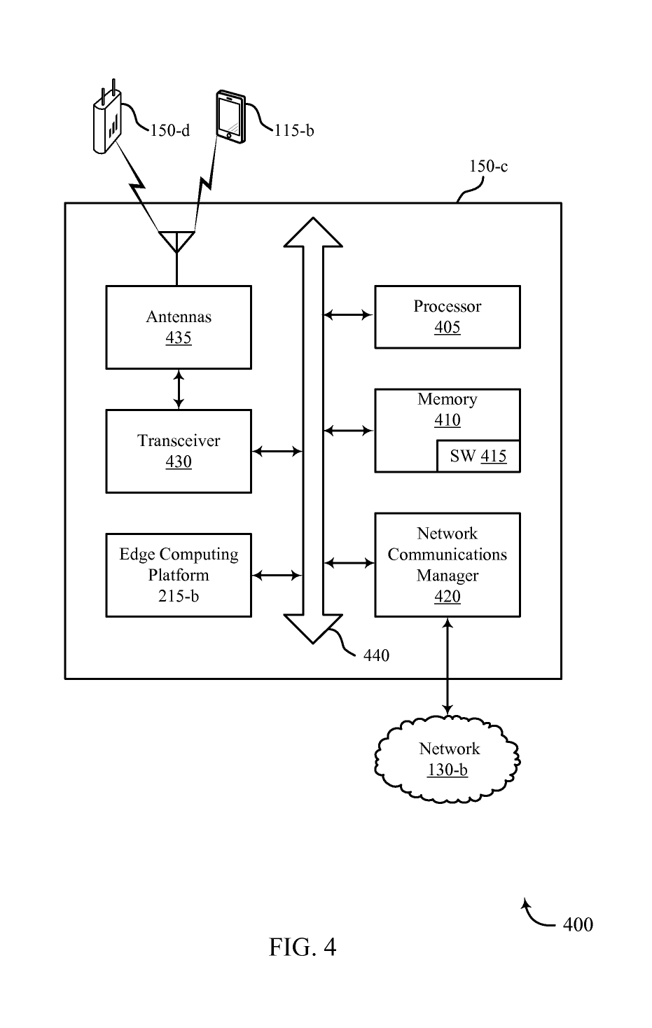

FIG. 4 shows a diagram 400 that illustrates a small cell base station 150-c configured for providing edge computing resources co-located with the small cell base station 150-c, in accordance with various aspects of the present disclosure. In some aspects, the small cell base station 150-c may be an example of the small cell base stations 150 of FIGS. 1A-1B. The small cell base station 150-c may include a processor 405, a memory 410, a transceiver 430, antennas 435, and an edge computing platform 215-b. The edge computing platform 215-b may be an example of the edge computing platform 215 of FIGS. 2-3. In some examples, the small cell base station 150-c may also include a network communications manager 420. Each of processor 405, memory 410, transceiver 430, network communications manager 420, and edge computing platform 215-b may be in communication with each other, directly or indirectly, over at least one bus 440.

The memory 410 may include random access memory (RAM) and read-only memory (ROM). The memory 410 may also store computer-readable, computer-executable software (SW) code 415 containing instructions that are configured to, when executed, cause the processor 405 to perform various functions described herein to provide edge computing resources to wireless devices in communication with the small cell base station 150-c, for example as further described with reference to FIGS. 1A, 1B, 2, and 3. Alternatively, the code 415 may not be directly executable by the processor 405 but be configured to cause the small cell base station 150-c, e.g., when compiled and executed, to perform functions described herein.

The processor 405 may include an intelligent hardware device, e.g., a central processing unit (CPU), a microcontroller, an ASIC, etc. The processor 405 may process information received through the transceiver 430 and/or the network communications manager 420. The processor 405 may also process information to be sent to the transceiver 430 for transmission through the antennas 435 and/or to the network communications manager 420. The processor 405 may handle, alone or in connection with the edge computing platform 215-b, various aspects related to providing edge computing resources to wireless devices connected to the small cell base station 150-c.

The transceiver 430 may include a modem configured to modulate packets and provide the modulated packets to the antennas 435 for transmission as well as to demodulate packets received from the antennas 435. The transceiver 430 may be implemented as at least one transmitter module and at least one separate receiver module. The transceiver 430 may be configured to communicate bi-directionally, via the antennas 435, with at least one wireless device 115 as illustrated in FIGS. 1A and 1B, for example. The small cell base station 150-c may typically include multiple antennas 435 (e.g., an antenna array). The small cell base station 150-c may communicate with a core network 130-b through the network communications manager 420. Using the transceiver 430 and antennas 435, the small cell base station 150-c may communicate with other small cell base stations 150, such as small cell base station 150-d using the transceiver 430 and antennas 435.

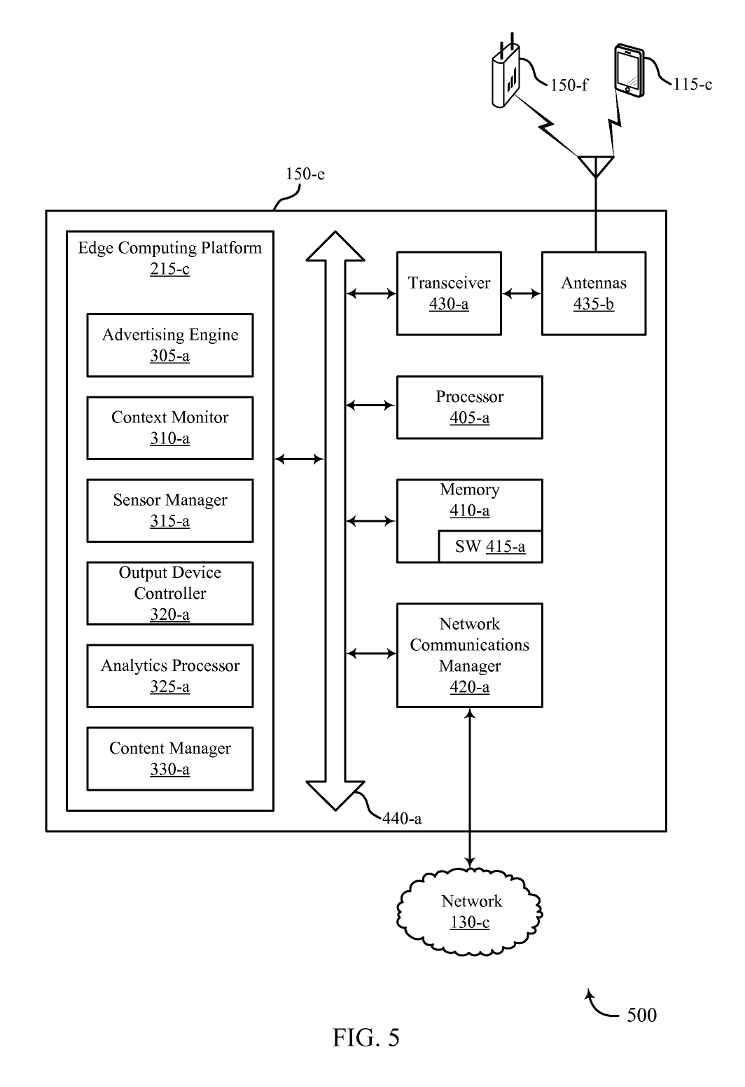

The components of small cell base station 150-c may be configured to implement aspects discussed above with reference to FIGS. 1A, 1B, 2, and 3, and those aspects are not repeated here for the sake of brevity. Moreover, the components of the small cell base station 150-c are not configured to implement aspects discussed below with respect to FIGS. 5-12 and those aspects may not be repeated here, also for the sake of brevity.

FIG. 5 shows a block diagram 500 of another small cell base station configured for providing edge computing resources co-located with the small cell base station 150-e, in accordance with various aspects of the present disclosure. In some aspects, the small cell 150-e may be an example of the small cell base stations 150 of FIGS. 1A-1B and 4. The small cell base station 150-e may include processor 405-a, memory 410-a, software (SW) code 415-a, network communications manager 420-a, transceiver 430-a, and antennas 435-a, which may be examples of processor 405, memory 410, software (SW) code 415, network communications manager 420, transceiver 430, and antennas 435, respectively, as described with reference to FIG. 4. The edge computing platform 215-d may also be an example of the edge computing platform 215 of FIGS. 2-4. Each of processor 405-a, memory 410-a, transceiver 430-a, network communications manager 420-a, and edge computing platform 215-c may be in communication with each other, directly or indirectly, over at least one bus 440-a.

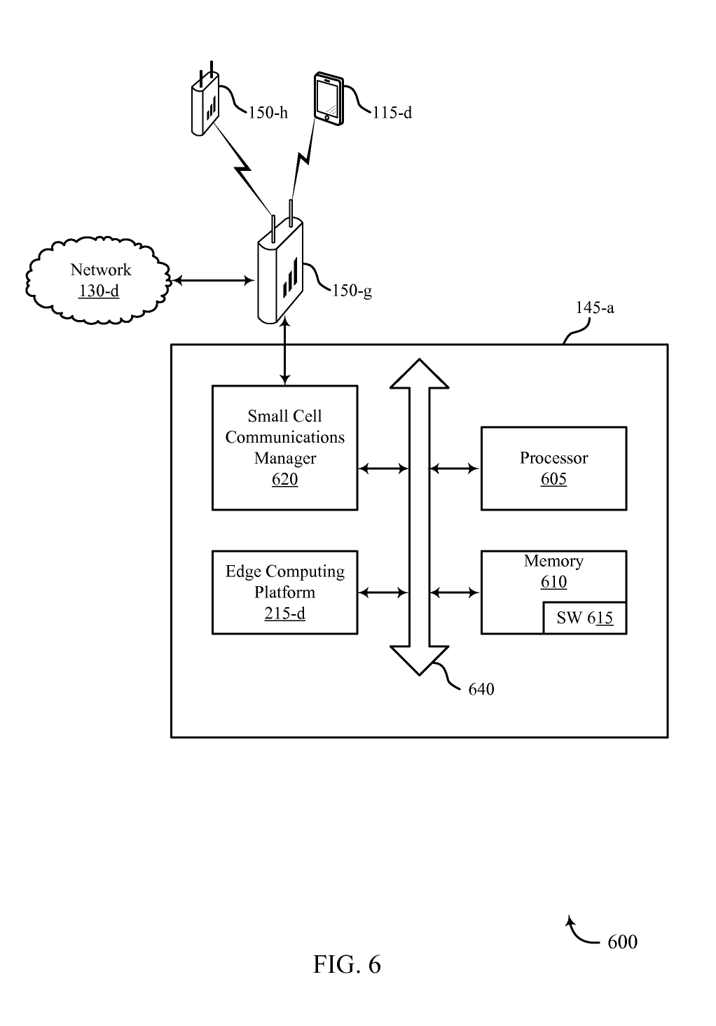

The components of small cell base station 150-e may be configured to implement aspects discussed above with reference to FIGS. 1A, 1B, 2, 3, and 4, and those aspects may not be repeated here for the sake of brevity. In addition, edge computing platform 215-c may include advertising engine 305-a, context monitor 310-a, sensor manager 315-a, output device controller 320-a, analytics processor 325-a, and content manager 330-a, which may be examples of advertising engine 305, context monitor 310, sensor manager 315, output device controller 320, analytics processor 325, and content manager 330, respectively, as described with reference to FIG. 3. Moreover, the components of the small cell base station 150-e may be configured to implement aspects discussed below with respect to FIGS. 6-12 and those aspects may not be repeated here, also for the sake of brevity.

FIG. 6 shows a diagram 600 that illustrates an edge computing device 145-a configured for providing edge computing resources co-located with the small cell base station 150-g, in accordance with various aspects of the present disclosure. In FIG. 6, the small cell base station 150-g is physically distinct from the edge computing device 145-a. Edge computing device 145-a may include a processor 605, a memory 610, a small cell communications manager 620, and an edge computing platform 215-d.

The edge computing platform 215-d may be one or more aspects of an example of the edge computing platform 215 of FIGS. 2-5. Edge computing platform 215-d may communicate, via the small cell communications manager 620, with a core network 130-d to which the small cell base station 150-g is connected. In some aspects, the small cell base station 150-g and a small cell base station 150-h may be an example of the small cell base stations 150 of FIGS. 1A-1B and 4-5. Likewise, the wireless device 115-d may be an example of the wireless devices 115 of FIGS. 1A-1B and 4-5.

The components of the edge computing device 145-a may be configured to implement aspects discussed above with reference to FIGS. 1A-5, and those aspects may not be repeated here for the sake of brevity.

The processor 605 may be one or more aspects of an example of the processor 405 of FIG. 4. The processor 605 may include an intelligent hardware device, e.g., a CPU, a microcontroller, an ASIC, etc. The processor 605 may process information received through the small cell communications manager 620 or edge computing platform 215-d. The processor 605 may also process information to be sent to the transceiver 430 for transmission via the small cell communications manager 620. The processor 605 may handle, alone or in connection with the edge computing platform 215-d, various aspects related to providing edge computing resources to wireless devices connected to the small cell base station 150-g. In some examples, the processor 605 is the edge computing platform 215-d.

The memory 610 may be an example of the memory 410 of FIG. 4. The memory 410 may store computer-readable, computer-executable software (SW) code 615 containing instructions that are configured to, when executed, cause the processor 605 to perform various functions described herein to provide edge computing resources to wireless devices connected to a small cell base station, for example as further described with reference to FIGS. 1A-5. Alternatively, the code 615 may not be directly executable by the processor 605 but be configured to cause the computer, e.g., when compiled and executed, to perform functions described herein.

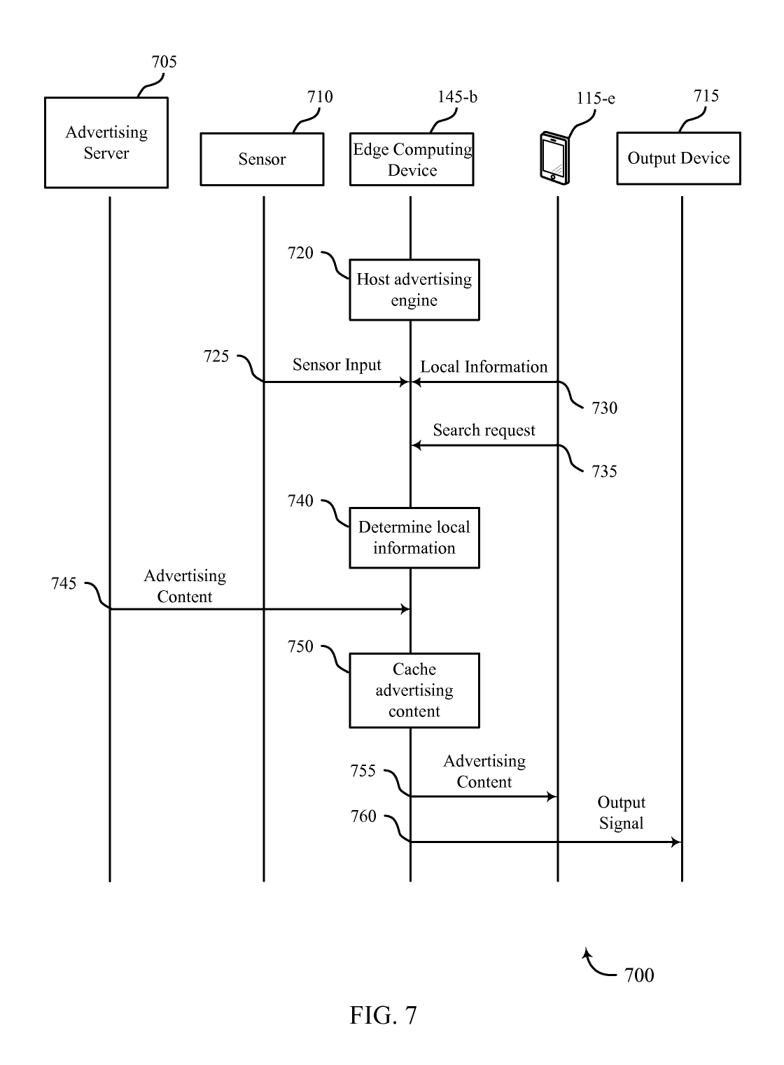

Moreover, the components of the edge computing device 145-a may be configured to implement aspects discussed below with respect to respect to FIGS. 7-12 and those aspects may not be repeated here also for the sake of brevity.

FIG. 7 illustrates an example of a process flow 700 for enriched advertising for a small cell in accordance with various aspects of the present disclosure. Process flow 700 may include an edge computing device 145-b, a wireless device 115-e, each of which may perform the respective functions described with reference to FIGS. 1-6. Process flow 700 may also include advertising server and content manager 705, sensor 710, and output device 715. The edge computing device 145-d may be co-located with a small cell base station 150. The edge computing device 145-d may have a coverage area or service footprint that enables service for communication devices that are within hyper proximity to the edge computing device 145-d; thus, the edge computing device 145-b may be aware of intimate details and aspects of the location in which the edge computing device 145-d is situated. Accordingly, the edge computing device 145-b may provide finer-granularity instructions to communication devices (e.g., wireless device 115, sensor 710, or output device 715) than larger cells (e.g., a macro cell). Wireless device 115-e, sensor 710, and output device 715 may both be located within hyper-proximity to edge computing device 145-b.

At 720, the edge computing device 145-b may host an advertising engine. Edge computing device 145-b may co-located with a small cell base station. The hosted advertising engine may also be an advertising server to serve advertising content to wireless devices connected to the small cell base station.

At 725, the edge computing device 145-b may receive an input from sensor 710. Sensor 710 may be a sensor to receive or measure light, sound, temperature, humidity, touch, smells, or motion, e.g. a microphone, a temperature sensor, a light sensor, an accelerometer, a gyroscope, a camera, an odor sensor, etc. Sensor 710 may communicate with and provide a sensor input to sensor manager 315, as described with reference to FIGS. 1-6. At 730, the edge computing device 145-b may receive local information regarding wireless device 115-e from wireless device 115-e. As further described above, such local information may include analytics data stored or processed by wireless device 115-e or location or trajectory data for wireless device 115-e, e.g. data obtained from a global positioning system (GPS) sensor of wireless device 115-e, etc. At 735, the edge computing device 145-b may also receive search requests or other requests for data made by wireless device 115-e from a remote server (e.g. a search engine, artificial intelligence, or email server, etc.). Edge computing device 145-b may read and analyze such requests. Some of 725, 730, and 735 are optional, and may also occur in other orders.

At 740, edge computing device 145-b may determine local information regarding an operating context of wireless device 115-e from one or more of sensor input 725, local information 730, or search request 735.

At 745, edge computing device 145-b may obtain advertising content from advertising content server 705. As discussed above, advertising content may include both commercial messages, for example regarding a product or service for sale, but may also refer to the display, communication, or other dissemination of information to a user. The advertising content may then be stored or cached at edge computing device 145-b at 750, for example in content manager 330, described with reference to FIGS. 3 and 5. A rich version of the advertising content may also be stored along with a standard, non-rich version of the advertising content based on the local information. In some examples, the advertising content may be modified based in part on the determined local information. In an example, portions of advertising content may be inserted into the obtained advertising content based on an analyzed search request. In another example, a sensor input such as a picture may be inserted into the stored advertising content. The advertising content may also be obtained and cached prior to receiving sensor input at 725. In other examples, advertising content may also be obtained and cached prior to receiving local information at 730 and/or search request 735.

Edge computing device 145-b may then transmit advertising content 755 to wireless device 115-e or provide an output signal 760 to output device 715 based at least in part on the local information determined at 740. The transmitted advertising content 755 may be advertising content that has been modified based on the determined local information. Edge computing device 145-b may also transmit output signal 760 including data or content to advertise or otherwise communicate information by physically augmenting the experience of a wireless device user using output device 715. For example, output device 715 may display an image, emit a sound, emit a smell, vibrate, or move at the output device 715. In one example, output device 715 may be coupled to an item that a user is attempting to locate in a store aisle to guide a user to that item, or page or alert a real or virtual assistant to assist the user at the user's location. Output device 715 may be one or more of various devices that provide a physical output, e.g. displays, lights, arrays of lights, projectors, signs, printers, speakers, vibrators, odor emitters, etc., in response to output signal 760. Output device 715 may be under the control of, and provide feedback data to, output device controller 320, as described with reference to FIGS. 1-6.

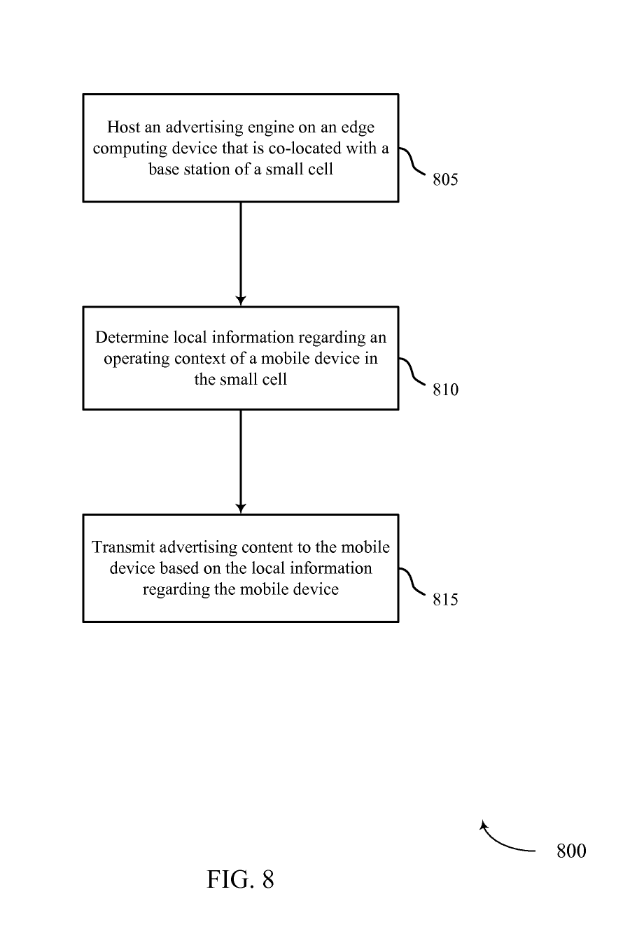

FIG. 8 shows a flowchart illustrating a method 800 for enriched local advertising for small cells in accordance with various aspects of the present disclosure. The operations of method 800 may be implemented by a small cell base station 150 or its components as described with reference to FIGS. 1A-1B and 4-5, an edge computing device 145 or its components as described with reference to FIGS. 1B and 6, and/or an edge computing device 205 or its components as described with reference to FIGS. 2-3. For example, the operations of method 800 may be performed by the edge computing platform 215 as described with reference to FIGS. 2-6. In some examples, a small cell base station 150, an edge computing device 145, and/or an edge computing device 205 may execute a set of codes to control the functional elements of the small cell base station 150, edge computing device 145, and/or edge computing device 205 to perform the functions described below. Additionally or alternatively, the small cell base station 150, edge computing device 145, and/or edge computing device 205 may perform aspects the functions described below using special-purpose hardware.

At block 805, the small cell base station 150, edge computing device 145, and/or edge computing device 205 may host an advertising engine on an edge computing device that is co-located with a small cell base station as described with reference to FIGS. 1B-6. In certain examples, the operations of block 805 may be performed by the advertising engine 305 as described with reference to FIGS. 3 and 5.

At block 810, the small cell base station 150, edge computing device 145, and/or edge computing device 205 may determine local information regarding an operating context of a mobile device in the small cell base station as described with reference to FIGS. 1B-6. In certain examples, the operations of block 810 may be performed by the context monitor 310 as described with reference to FIGS. 3 and 5.

At block 815, the small cell base station 150, edge computing device 145, and/or edge computing device 205 may transmit advertising content to the mobile device based at least in part on the local information regarding the mobile device as described with reference to FIGS. 1B-6. In certain examples, the operations of block 815 may be performed by the advertising engine 305 as described with reference to FIGS. 3 and 5.

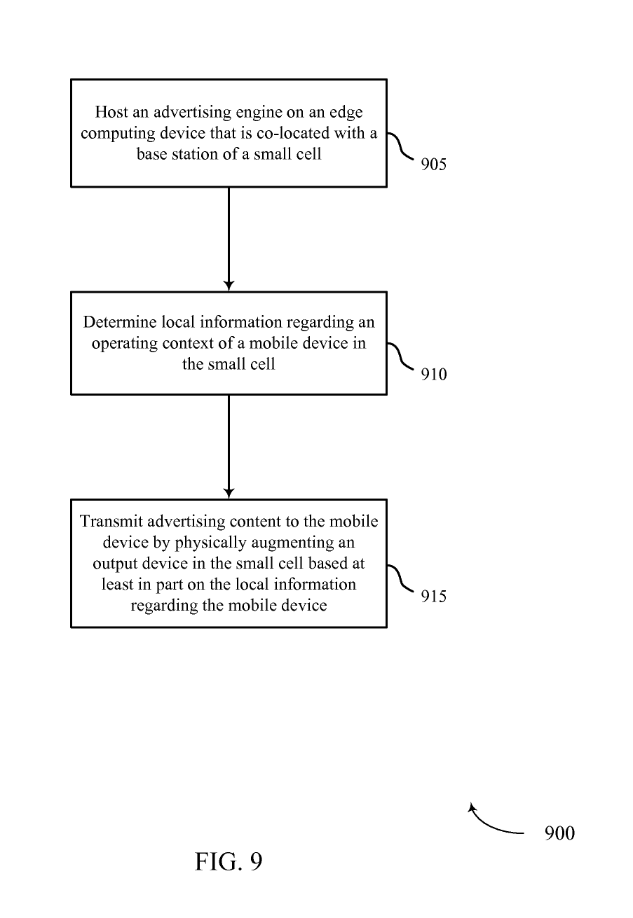

FIG. 9 shows a flowchart illustrating a method 900 for enriched local advertising for small cells in accordance with various aspects of the present disclosure. The operations of method 900 may be implemented by a small cell base station 150 or its components as described with reference to FIGS. 1A-1B and 4-5, an edge computing device 145 or its components as described with reference to FIGS. 1B and 6, and/or an edge computing device 205 or its components as described with reference to FIGS. 2-3. For example, the operations of method 900 may be performed by the edge computing platform 215 as described with reference to FIGS. 2-6. In some examples, a small cell base station 150, an edge computing device 145, and/or an edge computing device 205 may execute a set of codes to control the functional elements of the small cell base station 150, edge computing device 145, and/or edge computing device 205 to perform the functions described below. Additionally or alternatively, the small cell base station 150, edge computing device 145, and/or edge computing device 205 may perform aspects the functions described below using special-purpose hardware. The method 900 may also incorporate aspects of method 800 of FIG. 8.

At block 905, the small cell base station 150, edge computing device 145, and/or edge computing device 205 may host an advertising engine on an edge computing device that is co-located with a small cell base station as described with reference to FIGS. 1B-6. In certain examples, the operations of block 905 may be performed by the advertising engine 305 as described with reference to FIGS. 3 and 5.

At block 910, the small cell base station 150, edge computing device 145, and/or edge computing device 205 may determine local information regarding an operating context of a mobile device in the small cell base station as described with reference to FIGS. 1B-6. In certain examples, the operations of block 910 may be performed by the context monitor 310 as described with reference to FIGS. 3 and 5.

At block 915, the small cell base station 150, edge computing device 145, and/or edge computing device 205 may transmit advertising content to the mobile device by physically augmenting the experience of a user at an output device in the small cell base station based at least in part on the local information regarding the mobile device as described with reference to FIGS. 1B-6. Physical augmentation of the user experience may be performed to deliver advertising content in the form of a commercial advertisement, for example to encourage a user to purchase a product or service. However, physical augmentation may relate to augmenting the user experience at the output device to display, communicate, or other disseminate information to a user. In certain examples, the operations of block 915 may be performed by the advertising engine 305 and output device controller 320 as described with reference to FIGS. 3 and 5.

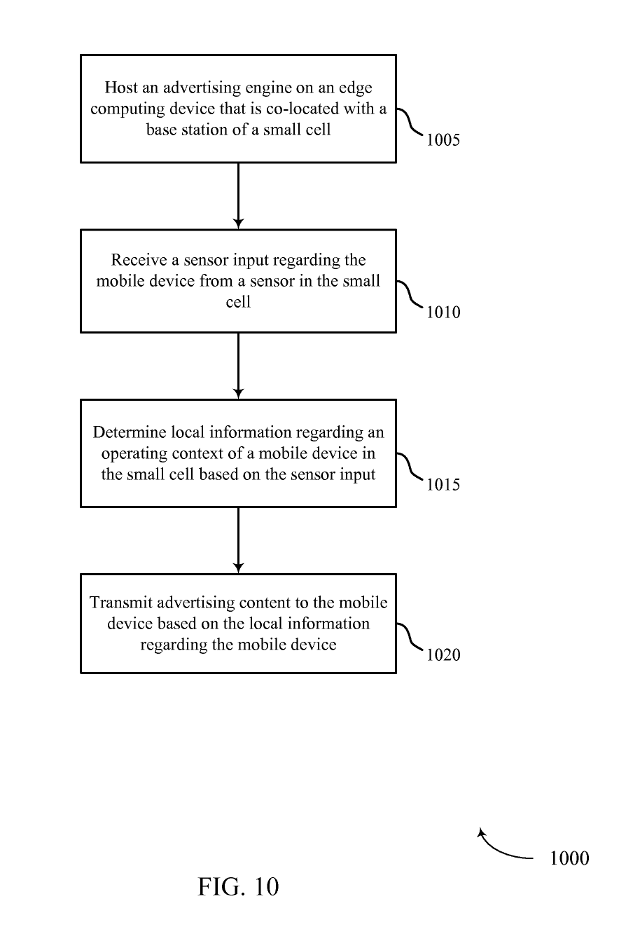

FIG. 10 shows a flowchart illustrating a method 1000 for enriched local advertising for small cell base stations in accordance with various aspects of the present disclosure. The operations of method 1000 may be implemented by a small cell base station 150 or its components as described with reference to FIGS. 1A-1B and 4-5, an edge computing device 145 or its components as described with reference to FIGS. 1B and 6, and/or an edge computing device 205 or its components as described with reference to FIGS. 2-3. For example, the operations of method 1000 may be performed by the edge computing platform 215 as described with reference to FIGS. 2-6. In some examples, a small cell base station 150, an edge computing device 145, and/or an edge computing device 205 may execute a set of codes to control the functional elements of the small cell base station 150, edge computing device 145, and/or edge computing device 205 to perform the functions described below. Additionally or alternatively, the small cell base station 150, edge computing device 145, and/or edge computing device 205 may perform aspects the functions described below using special-purpose hardware. The method 1000 may also incorporate aspects of methods 800, and 900 of FIGS. 8-9.

At block 1005, the small cell base station 150, edge computing device 145, and/or edge computing device 205 may host an advertising engine on an edge computing device that is co-located with a small cell base station as described with reference to FIGS. 1B-6. In certain examples, the operations of block 805 may be performed by the advertising engine 305 as described with reference to FIGS. 3 and 5.

At block 1010, the small cell base station 150, edge computing device 145, and/or edge computing device 205 may receive a sensor input regarding the mobile device from a sensor in the small cell base station, as described with reference to FIGS. 1B-6. In certain examples, the operations of block 1010 may be performed by the sensor manager 315 as described with reference to FIGS. 3 and 5.

At block 1015, the small cell base station 150, edge computing device 145, and/or edge computing device 205 may determine local information regarding an operating context of the mobile device based on the sensor input as described with reference to FIGS. 1B-6. In certain examples, the operations of block 1015 may be performed by the context monitor 310 as described with reference to FIGS. 3 and 5.

At block 1020, the small cell base station 150, edge computing device 145, and/or edge computing device 205 may transmit advertising content to the mobile device based on the local information regarding the mobile device as described with reference to FIGS. 1B-6. In certain examples, the operations of block 1020 may be performed by the advertising engine 305 as described with reference to FIGS. 3 and 5.

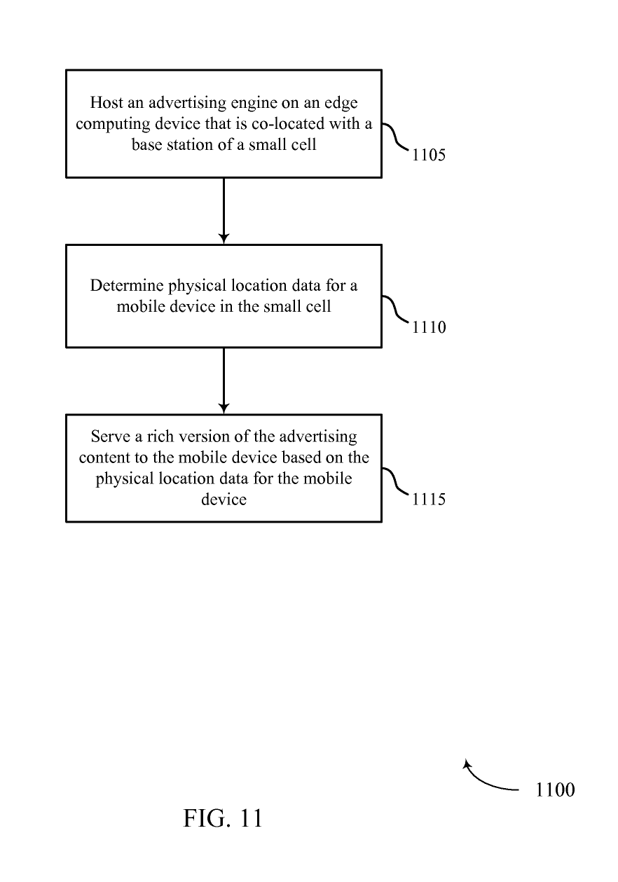

FIG. 11 shows a flowchart illustrating a method 1100 for enriched local advertising for small cell base station s in accordance with various aspects of the present disclosure. The operations of method 1100 may be implemented by a small cell base station 150 or its components as described with reference to FIGS. 1A-1B and 4-5, an edge computing device 145 or its components as described with reference to FIGS. 1B and 6, and/or an edge computing device 205 or its components as described with reference to FIGS. 2-3. For example, the operations of method 1100 may be performed by the edge computing platform 215 as described with reference to FIGS. 2-6. In some examples, a small cell base station 150, an edge computing device 145, and/or an edge computing device 205 may execute a set of codes to control the functional elements of the small cell base station 150, edge computing device 145, and/or edge computing device 205 to perform the functions described below. Additionally or alternatively, the small cell base station 150, edge computing device 145, and/or edge computing device 205 may perform aspects the functions described below using special-purpose hardware. The method 1100 may also incorporate aspects of methods 800, 900, and 1000 of FIGS. 8-10.

At block 1105, the small cell base station 150, edge computing device 145, and/or edge computing device 205 may host an advertising engine on an edge computing device that is co-located with a small cell base station as described with reference to FIGS. 1B-6. In certain examples, the operations of block 1105 may be performed by the advertising engine 305 as described with reference to FIGS. 3 and 5.

At block 1110, the small cell base station 150, edge computing device 145, and/or edge computing device 205 may determine physical location data for a mobile device in the small cell base station as described with reference to FIGS. 1B-6. In certain examples, the operations of block 1110 may be performed by the context monitor 310 as described with reference to FIGS. 3 and 5.

At block 1115, the small cell base station 150, edge computing device 145, and/or edge computing device 205 may serve a rich version of the advertising content to the mobile device based on the physical location data for the mobile device as described with reference to FIGS. 1B-6. In certain examples, the operations of block 1115 may be performed by the advertising engine 305 as described with reference to FIGS. 3 and 5.

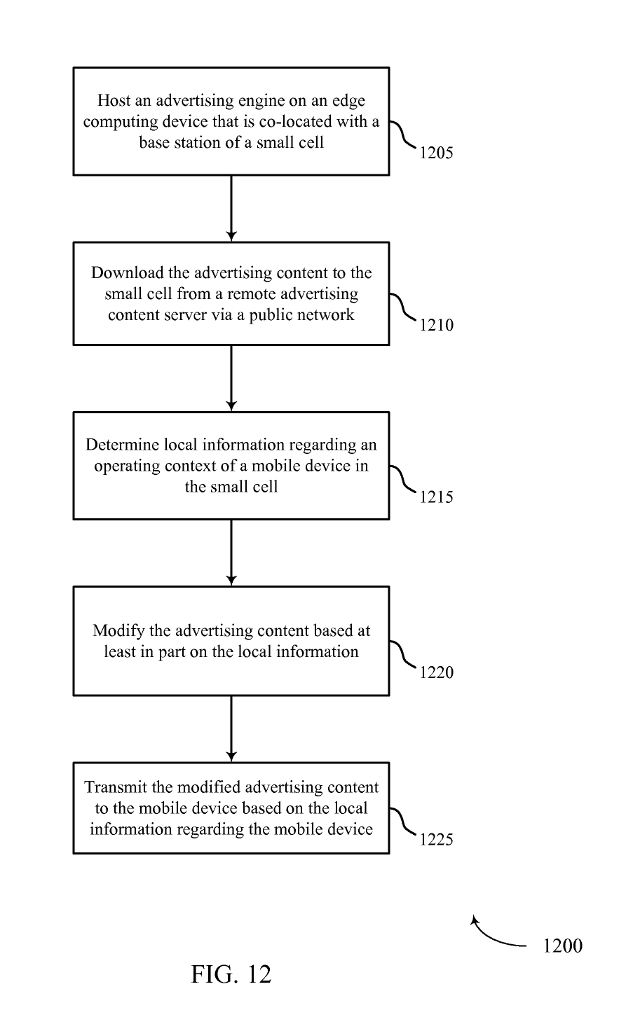

FIG. 12 shows a flowchart illustrating a method 1200 for enriched local advertising for small cell base stations in accordance with various aspects of the present disclosure. The operations of method 1200 may be implemented by a small cell base station 150 or its components as described with reference to FIGS. 1A-1B and 4-5, an edge computing device 145 or its components as described with reference to FIGS. 1B and 6, and/or an edge computing device 205 or its components as described with reference to FIGS. 2-3. For example, the operations of method 1200 may be performed by the edge computing platform 215 as described with reference to FIGS. 2-6. In some examples, a small cell base station 150, an edge computing device 145, and/or an edge computing device 205 may execute a set of codes to control the functional elements of the small cell base station 150, edge computing device 145, and/or edge computing device 205 to perform the functions described below. Additionally or alternatively, the small cell base station 150, edge computing device 145, and/or edge computing device 205 may perform aspects the functions described below using special-purpose hardware. The method 1200 may also incorporate aspects of methods 800, 900, 1000, and 1100 of FIGS. 8-11.

At block 1205, the small cell base station 150, edge computing device 145, and/or edge computing device 205 may host an advertising engine on an edge computing device that is co-located with a small cell base station as described with reference to FIGS. 1B-6. In certain examples, the operations of block 1205 may be performed by the advertising engine 305 as described with reference to FIGS. 3 and 5.

At block 1210, the small cell base station 150, edge computing device 145, and/or edge computing device 205 may download the advertising content to the small cell base station from a remote advertising content server via a network as described with reference to FIGS. 1B-6. In certain examples, the operations of block 1210 may be performed by the advertising engine 305 as described with reference to FIGS. 3 and 5.

At block 1215, the small cell base station 150, edge computing device 145, and/or edge computing device 205 may determine local information regarding an operating context of a mobile device in the small cell base station as described with reference to FIGS. 1B-6. In certain examples, the operations of block 1215 may be performed by the context monitor 310 as described with reference to FIGS. 3 and 5.

At block 1220, the small cell base station 150, edge computing device 145, and/or edge computing device 205 may modify the advertising content based at least in part on the local information as described with reference to FIGS. 1B-6. In certain examples, the operations of block 1220 may be performed by the advertising engine 305 as described with reference to FIGS. 3 and 5.

At block 1225, the small cell base station 150, edge computing device 145, and/or edge computing device 205 may transmit the modified advertising content to the mobile device based on the local information regarding the mobile device as described with reference to FIGS. 1B-6. In certain examples, the operations of block 1225 may be performed by the advertising engine 305 as described with reference to FIGS. 3 and 5.

Thus, methods 800, 900, 1000, 1100, and 1200 may provide for enriched local advertising for small cells. It should be noted that methods 800, 900, 1000, 1100, and 1200 describe possible implementation, and that the operations and the steps may be rearranged or otherwise modified such that other implementations are possible. In some examples, aspects from two or more of the methods 800, 900, 1000, 1100, and 1200 may be combined.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
hosting an advertising engine on an edge computing device that is co-located with a base station of a small cell;
determining local information regarding an operating context of a mobile device in the small cell; and
transmitting advertising content to the mobile device based at least in part on the local information regarding the mobile device.

2. The method of claim 1, wherein transmitting the advertising content to the mobile device comprises physically augmenting an output device in the small cell.

3. The method of claim 1, further comprising:
receiving a sensor input regarding the mobile device from a sensor in the small cell,
wherein determining the local information regarding the operating context of the mobile device is based at least in part on the sensor input.

4. The method of claim 1, wherein the local information comprises physical location data for the mobile device, the method further comprising:
transmitting a rich version of the advertising content to the mobile device based at least in part on the local information regarding the mobile device.

5. The method of claim 4, further comprising:
determining whether to a transmit the rich version of the advertising content based at least in part on the local information regarding the mobile device, wherein the local information is one or more of a link quality for a link between the small cell and the mobile device, a power state of the mobile device, a memory availability value, a processing availability value, or a coexistence scenario for different radios of the mobile device.

6. The method of claim 1, further comprising:
downloading the advertising content to the small cell from a remote advertising content server via a network; and
modifying the advertising content based at least in part on the local information.

7. The method of claim 6, further comprising:
caching the modified advertising content at the small cell for access by the advertising engine.

8. The method of claim 1, further comprising:
prefetching the advertising content to the edge computing device based at least in part on the local information regarding the operating context of the mobile device.

9. The method of claim 1, wherein the local information comprises physical location data for the mobile device, the method further comprising:
updating the advertising content based at least in part on the physical location data.

10. The method of claim 1, further comprising:
analyzing a search request made by the mobile device to generate a search analysis; and
prefetching the advertising content based at least in part on the search analysis.

11. The method of claim 1, further comprising:
processing analytics for the mobile device at the edge computing device.

12. The method of claim 11, further comprising:
allocating processing of the analytics between the edge computing device and the mobile device.

13. The method of claim 1, wherein transmitting the advertising content to the mobile device comprises:
augmenting an output device in the small cell, wherein augmenting the output device is one or more of displaying an image, emitting a sound, emitting a smell, vibrating, or moving at the output device.

14. The method of claim 1, further comprising:
receiving a sensor input regarding the mobile device from a sensor in the small cell, such that determining the local information regarding the operating context of the mobile device is based at least in part on the sensor input, wherein the sensor is one or more of a microphone, a temperature sensor, a light sensor, a camera, or an odor sensor.

15. The method of claim 1, wherein the local information regarding the operating context of the mobile device is one or more of a physical location of the mobile device, a trajectory of the mobile device, or information regarding a plurality of neighboring mobile devices.

16. The method of claim 1, wherein:
the advertising engine includes an advertising server; and
transmitting the advertising content to the mobile device comprises serving the advertising content to the mobile device.

17. The method of claim 1, wherein
wireless communication resources of the base station are housed in a first module; and
the edge computing device is housed in a second module in communication with and co-located with the first module.

18. The method of claim 1, wherein the base station is one of a picocell, a femtocell, a microcell, or a Wi-Fi access point.

19. The method of claim 1, wherein the base station comprises a wireless wide area network (WWAN) transceiver and a wireless local area network (WLAN) transceiver.

20. An apparatus for wireless communication, comprising:
means for hosting an advertising engine on an edge computing device that is co-located with a base station of a small cell;
means for determining local information regarding an operating context of a mobile device in the small cell; and
in part on the local information regarding the mobile device.

21. The apparatus of claim 20, wherein the means for transmitting the advertising content to the mobile device comprises means for physically augmenting an output device in the small cell.

22. The apparatus of claim 20, further comprising:
means for receiving a sensor input regarding the mobile device from a sensor in the small cell, wherein determining the local information regarding the operating context of the mobile device is based at least in part on the sensor input.

23. The apparatus of claim 20, wherein the local information comprises physical location data for the mobile device, the apparatus further comprising:
means for transmitting a rich version of the advertising content to the mobile device based at least in part on the local information regarding the mobile device.

24. An edge computing device that is co-located with a base station of a small cell, the edge computing device comprising:
a processor;
memory in electronic communication with the processor; and
instructions stored in the memory, the instructions being executable by the processor to:
host an advertising engine on the edge computing device;
determine local information regarding an operating context of a mobile device in the small cell; and
transmit advertising content to the mobile device based at least in part on the local information regarding the mobile device.

25. The edge computing device of claim 24, wherein the instructions for transmitting the advertising content to the mobile device comprise instructions for physically augmenting an output device in the small cell.

26. The edge computing device of claim 24, the instructions being further executable by the processor to receive a sensor input regarding the mobile device from a sensor in the small cell, wherein determining the local information regarding the operating context of the mobile device is based at least in part on the sensor input.

27. The edge computing device of claim 24, wherein the local information comprises physical location data for the mobile device, the instructions being further executable by the processor to transmit a rich version of the advertising content to the mobile device based at least in part on the local information regarding the mobile device.

28. A non-transitory computer-readable medium storing computer-executable code for wireless communication, the code executable by a processor to:
host an advertising engine on an edge computing device that is co-located with a base station of a small cell;
determine local information regarding an operating context of a mobile device in the small cell; and
transmit advertising content to the mobile device based at least in part on the local information regarding the mobile device.

29. The non-transitory computer-readable medium of claim 28, wherein the code for transmitting the advertising content to the mobile device comprises code executable by the processor to physically augmenting an output device in the small cell.

30. The non-transitory computer-readable medium of claim 28, the code executable by the processor to:
transmit a rich version of the advertising content to the mobile device based at least in part on the local information regarding the mobile device, wherein the local information comprises physical location data for the mobile device.
